(19) United States
(12) Patent Application Publication
(10) Pub. No.: US 2013/0144498 A1
(43) Pub. Date: Jun. 6, 2013

(54) APPARATUS AND METHOD FOR CONTROLLING EMERGENCY BRAKING BASED ON CONDITION INFORMATION OF A VEHICLE

(71) Applicant: Jang Seop Kim, Ansan (KR)

(72) Inventor: Jang Seop Kim, Ansan (KR)

(73) Assignee: HYUNDAI MOTOR COMPANY, Seoul (KR)

(21) Appl. No.: 13/472,589

(22) Filed: May 16, 2012

(30) Foreign Application Priority Data
Dec. 6, 2011 (KR) 10-2011-0129737

(51) Int. Cl. B60T 7/12; B60T 17/22

(52) U.S. Cl. 701/70

(57) ABSTRACT

An apparatus for controlling emergency braking based on condition information of a vehicle includes an obstacle detection unit configured to detect an obstacle located on a road in front of the vehicle, information collection unit configured to collect the condition information of the vehicle through a vehicle network, controller configured to control the emergency braking of the vehicle upon analyzing the condition information collected by the information collection unit upon detection of the obstacle by the obstacle detection unit to determine whether the emergency braking is reliable, and an alarm unit configured to generate an alarm according to a control of the controller.

### CROSS-REFERENCES TO RELATED APPLICATIONS

Priority to Korean patent application number 10-2011-0129737, filed on Dec. 6, 2011, which is incorporated by reference in its entirety, is claimed.

### BACKGROUND OF THE INVENTION

1. Field of the Invention

The present invention relates to an apparatus and a method for controlling emergency braking based on condition information of a vehicle, and more particularly, to an apparatus and a method for controlling emergency braking based on condition information of a vehicle collected through vehicle network communication.

2. Description of the Related Art

Generally, a vehicle is equipped with a braking apparatus to decelerate or stop the vehicle when necessary. This braking apparatus includes a booster that doubles the of the pressure exerted by a brake pedal by using a vacuum pressure (or an engine suction pressure) generated via engine power, a master cylinder that forms brake oil pressure on a braking circuit based on the pressure exerted by the booster, and a wheel cylinder that decelerates a rotating speed or stops a rotation of a wheel via the brake oil pressure. The booster may be either a vacuum type that uses an engine intake manifold vacuum or an air type that uses a pressure from a compressor that is driven by an engine.

The vehicle starts braking after a driver depresses the brake pedal regardless of a configuration of the braking apparatus thereof. Thus, since this booster system is still reliant upon driver reflexes, the system is only as beneficial as the driver's abilities allow.

In order to compensate for this defect in the above system, an advanced emergency brake system (AEBS) has been contemplated by some auto manufactures. In this system, when an object exists in front of a vehicle in motion, emergency braking is performed regardless of whether the driver has already applied a brake based on a relative velocity of the vehicle with respect to the object and a distance therebetween.

However, in conventional AEBSs, the emergency braking is performed depending on the presence of the object in front of the vehicle and not based on the condition of the vehicle. Thus, the emergency braking is performed even when the emergency braking is not reliable, thus causing more serious damage.

### SUMMARY OF THE INVENTION

Accordingly, the present invention has been made in view of the above problems, and the present invention provides an apparatus and a method for controlling emergency braking based on condition information of a particular vehicle in which emergency braking is performed by determining whether emergency braking is reliable based on the condition information of the vehicle collected from a vehicle network. Accordingly, emergency braking is not performed when the emergency braking is not reliable, thereby preventing more serious damage to the vehicle and its passengers.

In one aspect of the present invention, an apparatus for controlling emergency braking based on condition information of a vehicle includes an obstacle detection unit configured to detect an obstacle located on a road in front of the vehicle; information collection unit configured to collect the condition information of the vehicle via a vehicle network; a controller configured to control the emergency braking of the vehicle upon analyzing the condition information collected by the information collection unit upon detection of the obstacle by the obstacle detection unit to determine whether the emergency braking is reliable; and an alarm unit configured to generate an alarm when the emergency braking is determined not to be reliable.

In another aspect of the present invention, a method of controlling emergency braking based on condition information of a vehicle includes detecting, by an obstacle detection unit, an obstacle located on a road in front of the vehicle; collecting, by information collection unit, condition information of the vehicle through a vehicle network; analyzing, by controller, the condition information collected by the information collection unit upon detection of the obstacle by the obstacle detection unit to determine whether the emergency braking is reliable; entering into an emergency braking mode when the emergency braking is determined to be reliable; and generating an alarm instead of entering into the emergency braking mode when the emergency braking is determined not to be reliable.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration view illustrating an exemplary embodiment of an apparatus for controlling emergency braking based on condition information of a vehicle according to the present invention; and

FIG. 2 is a flow chart illustrating an exemplary embodiment of a method of controlling emergency braking based on condition information of a vehicle according to the present invention.

### DETAILED DESCRIPTION OF THE INVENTION

Hereinafter, exemplary embodiments of the present invention will be described herein below with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

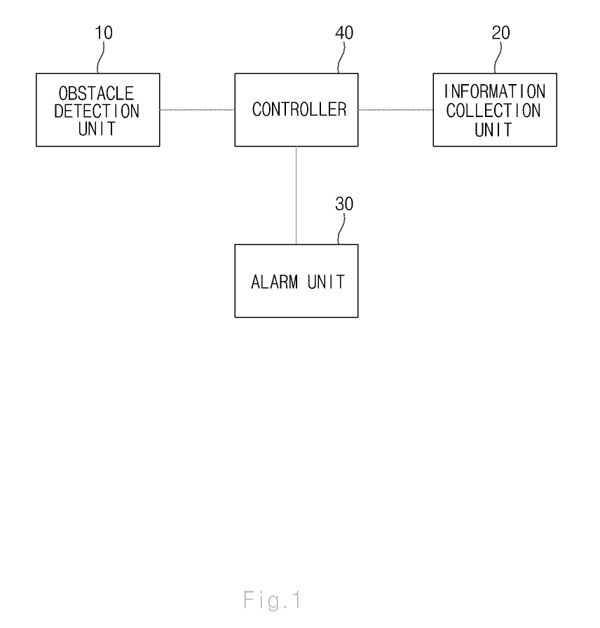

FIG. 1 is a configuration view illustrating an exemplary embodiment of an apparatus for controlling emergency braking based on condition information of a vehicle according to the present invention. As shown in FIG. 1, an apparatus for controlling emergency braking based on condition information of a vehicle includes an obstacle detection unit 10, an information collection unit 20, an alarm unit 30, and a controller 40.

Each element mentioned above will be described. First, the obstacle detection unit 10 is implemented as one of an infrared sensor, an ultrasound sensor, or radar and is mounted on a front portion of the vehicle to detect an obstacle located on a road on which the vehicle is being driven.

The information collection unit 20 collects the condition information of the vehicle from a vehicle network such as a controller area network (CAN), a local interconnect network (VIN), or a FlexRay™. The condition information of the vehicle may include the vehicle's weight, brake air pressure, tire pressure, a steering angle of a steering wheel, a degree to which an accelerator pedal is pressed, engine torque, and engine revolution per minute (RPM).

The tire pressure may be measured by a tire pressure monitoring system (TPMS) sensor to be transmitted to the vehicle network and the steering angle of the steering wheel is measured by a steering angle sensor to be transmitted to the vehicle network.

The alarm unit 30 generates an alarm according to a control of the controller 40. The controller 40 does not enter into an emergency braking mode immediately after detecting the obstacle by the obstacle detection unit 10. Rather, the controller 40 determines whether emergency braking is reliable based on the condition information of the vehicle collected by the information collection unit 20 and enters into the emergency braking mode based on a determination result. Here, the emergency braking mode is in a well known art that is generally used in an advanced emergency brake system (AEBS), and thus, a further description will be omitted. Such function of the controller 40 may be performed by an electronic control unit (ECU).

Hereinafter, a process of determining whether the emergency braking is reliable based on each condition information will be described. When the condition information is the weight of the vehicle and the weight of the vehicle exceeds a first threshold value, the vehicle is determined to exceed a load weight, thereby entering into the emergency braking mode quicker than a case of a normal condition by a predetermined time period (e.g., 1 second or 2 seconds). The purpose of this is to compensate for an increase in braking distance due to an increase in the weight of the vehicle.

When the condition information of the vehicle is the brake air pressure of the vehicle and the brake air pressure of the vehicle does not exceed a second threshold value, it is determined that a braking is difficult to perform due to the low brake air pressure so that the emergency braking mode is not entered and the alarm is generated through the alarm unit 30. Here, the controller 40 controls an air injection unit (not shown) such that the brake air pressure exceeds the second threshold value.

Furthermore, when the condition information of the vehicle is the tire pressure of the vehicle and the tire pressure does not exceed a third threshold value, it is determined that there exists a risk that the emergency braking may cause a flat tire due to the low tire pressure so that the emergency braking mode is not entered and the alarm is generated through the alarm unit 30.

When the condition information of the vehicle is the steering angle of the steering wheel and the steering angle of the steering wheel exceeds a fourth threshold value (e.g., ±5 degree), it is determined that the emergency braking may cause a vehicle to turnover. Thus, in this case, the emergency braking mode is not entered and the alarm is generated through the alarm unit 30.

When the condition information of the vehicle is the degree to which the acceleration pedal is pressed and the degree to which the acceleration pedal is pressed exceeds a fifth threshold value (e.g., 80%), it is determined that a risk of collision does not exist so that the emergency braking mode is not entered and the alarm is generated through the alarm unit 30. Here, the controller 40 controls a fuel injector (not shown) to interrupt fuel injection, thereby preventing unnecessary fuel consumption.

When the condition information of the vehicle is the engine torque and the engine torque exceeds a sixth threshold value (e.g., 100), the emergency braking mode is not entered and the alarm is generated through the alarm unit 30. Here, the controller 40 controls the fuel injector to interrupt the fuel injection, thereby preventing unnecessary fuel consumption.

When the condition information of the vehicle is the engine RPM and the engine RPM exceeds a seventh threshold value (e.g., 1600), the emergency braking mode is not entered and the alarm is generated through the alarm unit 30. Here, the controller 40 controls the fuel injector to interrupt the fuel injection, thereby preventing unnecessary fuel consumption.

The controller 40 may finally determine whether the emergency braking is reliable by combining any number of the above described processes of determining whether the emergency braking is reliable with respect to each condition information.

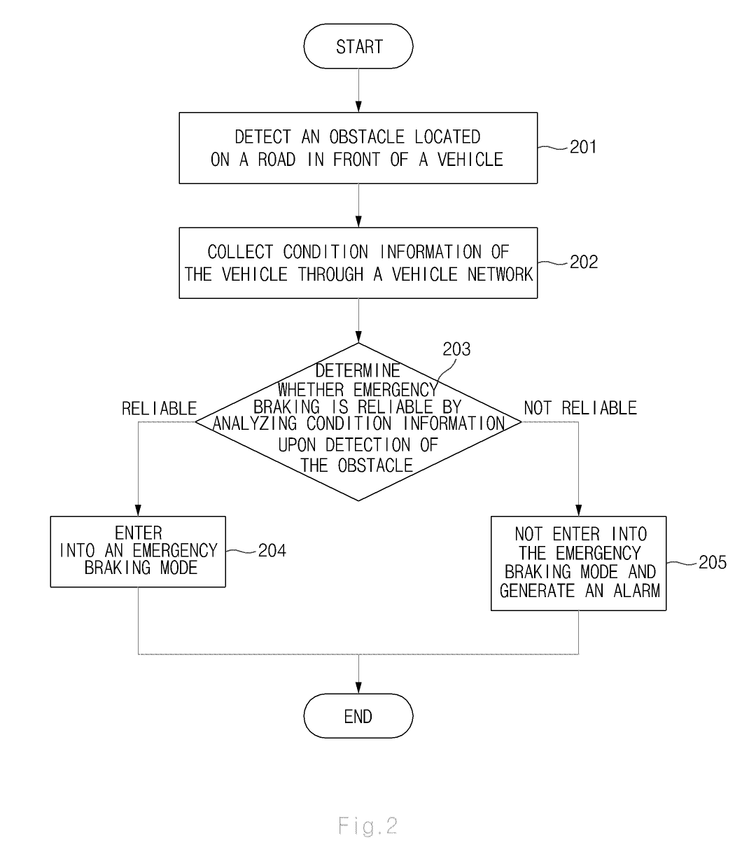

FIG. 2 is a flow chart illustrating an exemplary embodiment of a method of controlling emergency braking based on condition information of a vehicle according to the present invention. First, the obstacle detection unit 10 detects the obstacle located on a road in front of the vehicle (201). The information collection unit 20 collects the condition information of the vehicle via the vehicle network (202). The controller 40 determines whether the emergency braking is reliable by analyzing the condition information collected by the information collection unit 20 upon detection of the obstacle by the obstacle detection unit 10 (203). When it is determined that the emergency braking is reliable (203), the emergency braking mode is entered (204).

When it is determined that the emergency braking is not reliable (203), the emergency braking mode is not entered and the alarm is generated (205). Through this process, unnecessary damage may be avoided by not performing the emergency braking in a circumstance where the emergency braking is not reliable.

According to the present invention, emergency braking is performed by determining whether emergency braking is reliable based on the condition information of the vehicle collected from the vehicle network and the emergency braking is not performed when the emergency braking is not reliable, thereby preventing more serious damage.

Although the above exemplary embodiment is described as using a plurality of units to perform the above process, it is understood that the above processes may also be performed by a single controller or unit.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

In the above, although the embodiments of the present invention have been described with reference to the accompanying drawings, a person skilled in the art should apprehend that the present invention can be embodied in other specific forms without departing from the technical spirit or essential characteristics thereof. Thus, the embodiments described above should be construed as exemplary in every aspect and not limiting.

What is claimed is:

1. An apparatus for controlling emergency braking based on condition information of a vehicle, the apparatus comprising:
an obstacle detection unit configured to detect an obstacle located on a road in front of the vehicle;
information collection unit configured to collect the condition information of the vehicle via a vehicle network;
a controller configured to control the emergency braking of the vehicle after analyzing the condition information collected by the information collection unit upon detection of the obstacle by the obstacle detection unit to determine whether the emergency braking is reliable; and
an alarm unit configured to generate an alarm according to a control of the controller.

2. The apparatus according to claim 1, wherein the condition information of the vehicle includes at least one of the vehicle's weight, brake air pressure, tire pressure, a steering angle of a steering wheel, a degree to which an accelerator pedal is pressed, engine torque, and engine revolution per minute (RPM).

3. The apparatus according to claim 2, wherein, when the weight of the vehicle exceeds a first threshold value, the controller enters into an emergency braking mode quicker than during normal conditions by a predetermined time period.

4. The apparatus according to claim 2, wherein, when the brake air pressure of the vehicle does not exceed a second threshold value, the controller does not enter into an emergency braking mode and controls the alarm unit to generate an alarm.

5. The apparatus according to claim 4, further comprising:
an air injection unit, wherein the controller controls the air injection unit when the brake air pressure exceeds the second threshold value.

6. The apparatus according to claim 2, wherein, when
the tire pressure does not exceed a third threshold value, or
the steering angle of the steering wheel exceeds a fourth threshold value, the controller does not enter into an emergency braking mode and controls the alarm unit to generate an alarm.

7. The apparatus according to claim 2, wherein, when
the degree to which the acceleration pedal is pressed exceeds a fifth threshold value,
the engine torque exceeds a sixth threshold value, or
the engine RPM exceeds a seventh threshold value, the controller does not enter into
an emergency braking mode and controls the alarm unit to generate an alarm.

8. The apparatus according to claim 7, further comprising:
a fuel injector, wherein the controller controls the fuel injector to interrupt fuel injection.

9. A method of controlling emergency braking based on condition information of a vehicle, the method comprising:
detecting, by an obstacle detection unit, an obstacle located on a road in front of the vehicle;
collecting, by information collection unit, condition information of the vehicle through a vehicle network;
analyzing, by controller, the condition information collected by the information collection unit upon detection of the obstacle by the obstacle detection unit to determine whether the emergency braking is reliable;
entering into an emergency braking mode when the emergency braking is determined to be reliable; and
generating an alarm instead of entering into the emergency braking mode when the emergency braking is determined not to be reliable.

10. The method according to claim 9, wherein the condition information of the vehicle includes at least one of the vehicle's weight, brake air pressure, tire pressure, a steering angle of a steering wheel, a degree to which an accelerator pedal is pressed, engine torque, and engine revolution per minute (RPM).

11. A non-transitory computer readable medium containing program instructions executed by a processor or controller, the computer readable medium comprising:
program instructions that analyze condition information collected by an information collection unit from a vehicle network unit upon detection of an obstacle by the obstacle detection unit to determine whether the emergency braking is reliable;
program instructions that enter into an emergency braking mode when the emergency braking is determined to be reliable; and
program instructions that generate an alarm instead of entering into the emergency braking mode when the emergency braking is determined not to be reliable.
